(19) United States
(12) Patent Application Publication
(10) Pub. No.: US 2025/0339937 A1
(43) Pub. Date: Nov. 6, 2025

(54) WRENCH FOR USE IN CONFINED SPACES

(71) Applicant: Government of the United States as represented by the Secretary of the Air Force, Wright-Patterson AFB, OH (US)

(72) Inventor: Christian Schafer, Edmond, OK (US)

(21) Appl. No.: 18/652,009

(22) Filed: May 1, 2024

(51) Int. Cl. B25B 13/48; B25B 23/00

(52) U.S. Cl. CPC B25B 13/481; B25B 23/0028; B25B 23/0035

(57) ABSTRACT

An elongate wrench for rotating a threaded fastener. The wrench has a connected to a chain which, in turn, is connected to a drive shaft which receives a socket for engaging various threaded fasteners. The chain has alternating pins and links. The chain has an aspect ratio, defined as the ratio of the width across the rollers to the height of a link plate which is greater than 1. This aspect ratio advantageously provides high polar moment of inertia for torque and a narrow thickness for fitting into confined spaces. The chain articulates about as many pins as necessary to reach into the confined space.

### STATEMENT OF GOVERNMENT INTEREST

The invention described and claimed herein may be manufactured, licensed and used by and for the Government of the United States of America for all government purposes without the payment of any royalty.

### FIELD OF THE INVENTION

The present invention is related to a wrench suitable for use in confined spaces, more particularly to such a wrench which is articulable about plural, spaced apart parallel axes and even more particularly to such a wrench having an aspect ratio proximate the socket greater than 1.1, preferably greater than 1.2 and more preferably greater than 1.3.

### BACKGROUND OF THE INVENTION

Wrenches are a ubiquitous feature of society. Virtually every garage has a wrench of some sort for the inevitable maintenance to be performed. The wrench comprises a handle and a socket. The handle is grasped and manipulated by the user to apply torque in order to tighten or loosen a threaded fastener. The torque can be clockwise, counterclockwise or both in series as needed for the particular task. The threaded fastener includes nuts, bolts and screws.

The threaded fastener is engaged by a socket, as needed for a particular task. The socket may be a closed socket, typically referred to as a six point or 12 point socket, open end wrench socket or crowfoot socket. The threaded fastener may also be engaged by a screwdriver blade also known as a drive tip. Suitable screwdriver drive tips include flathead, Phillips, Pozidriv, Robertson/square, Torx/square, hex, spanner, Frearson, tri-angle, etc. Each of these sockets and drive tips are available in a variety of sizes.

The endless tasks requiring a wrench for maintenance often include confined spaces. Confined spaces include those spaces which have narrow opening, convoluted paths between the handle and socket and combinations thereof.

A wrench strong enough to apply sufficient torque will often not fit into the confined space. A smaller wrench may fit into the confined space but not be strong enough to apply the needed torque. Yet other problems occur when the confined space is not easily accessible. The wrench may be required to undergo various twists and turns between the handle as graspable by the user and the threaded fastener which may not even be visible in the confined space.

Various attempts have been made to overcome these problems. For example universal sockets articulate across two perpendicular axes are available. But there are situations which cannot tolerate more than articulation about a single direction axis. Flexible wire-wound extensions are also available, but limited to low torque applications. Yet other attempts include articulable extensions which can apply high torque, but have an aspect ratio approximating 1 and are unsuitable for many confined spaces.

Clearly a new approach is needed. Accordingly, it is an object of this invention to provide a wrench which decouples the low torque/high flexibility and high torque/low flexibility constraints of the prior art. It is further an object to provide a wrench capable of high torque applications in confined spaces.

### SUMMARY OF THE INVENTION

In one embodiment the invention comprises an elongate wrench for rotating a threaded fastener. The wrench defines a longitudinal axis LA and comprises a handle having a first handle end and a second handle end opposed thereto, a chain having a first chain end joined to the handle and a second chain end opposed thereto and spaced outwardly from the handle and a drive shaft joined to the second end of the chain and configured to insert into a bore of a socket, whereby the chain is articulable about a plurality of transverse axes perpendicular to the longitudinal axis LA and can apply torque about the longitudinal axis LA in response to a user.

In another embodiment the invention comprises a kit comprising a modular elongate wrench for rotating a threaded fastener and defining a longitudinal axis LA. The kit comprises at least one elongate handle coincident the longitudinal axis and having a first handle end and a second handle end opposed thereto, at least one chain having a proximal end removably joinable to the handle proximate the second handle end and having a distal end opposed to the proximal end and being spaced away from the handle and at least one drive shaft removably joinable to the distal end of the chain and configured to insert into a bore of a socket, whereby the chain is articulable about a plurality of transverse axes perpendicular to the longitudinal axis LA and can apply torque about the longitudinal axis LA.

In another embodiment the invention comprises a method of tightening or loosening a threaded fastener. The method comprises, in order, the steps of: providing a modular wrench for rotating a threaded fastener and defining a longitudinal axis LA, the wrench having at least one elongate handle coincident the longitudinal axis LA with a first handle end and a second handle end opposed thereto, at least one chain having a proximal end removably joined to the handle and a distal end opposed thereto and spaced outwardly from the handle, whereby the chain is articulable about a plurality of transverse axis perpendicular to the longitudinal axis LA, and a drive shaft removably joined to the distal end of the chain and configured to insert into a bore of a socket; removably attaching a first socket to the drive shaft; engaging the first socket with a threaded fastener; and applying torque about the longitudinal axis LA of the wrench to thereby rotate the threaded fastener about a respective threaded fastener axis.

### BRIEF DESCRIPTION OF THE DRAWINGS

All figures are to scale, except FIG. 6C, which specifies scale, and schematic FIG. 9.

FIG. 1 is a scale perspective view of an adjustable wrench according to the present invention.

FIG. 2 is a scale top plan view of the wrench according to FIG. 1 showing indeterminate length.

FIG. 3A is a scale side profile view of the adjustable wrench of FIG. 1 and a socket usable with this adjustable wrench.

FIG. 3B is a scale opposite side elevational view of the wrench of FIG. 1.

FIG. 4A is a scale perspective view of the wrench of FIG. 1 showing applied torque around the longitudinal axis.

FIG. 4B is a scale perspective view of the wrench of FIG. 1 showing applied torque perpendicular to the longitudinal axis.

FIG. 5 is a scale end view of the wrench of FIG. 1.

FIG. 6A is a scale detailed fragmentary side elevational view of a chain usable with the wrench of the present invention.

FIG. 6B is a scale detailed fragmentary side top plan view of the chain of FIG. 6A.

FIG. 6C is a table of ANSI B29.1 chain standards.

FIG. 7A is a scale perspective view, shown partially in cutaway, of a socket usable with the wrench of the present invention.

FIG. 7B is a scale bottom plan view of the socket of FIG. 6A with a hex nut therein.

FIG. 8A is a scale adapter usable with the wrench of the present invention.

FIG. 8B is a scale extension usable with the wrench of the present invention.

FIG. 9 is a schematic view of a kit having plural handles, chains and drive shafts.

### DETAILED DESCRIPTION OF THE INVENTION

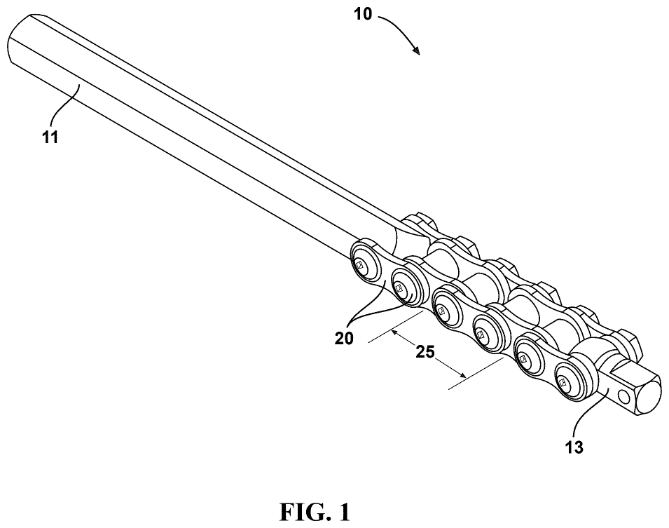

Referring to FIG. 1, the wrench 10 according to the present invention comprises a handle 11 for grasping and manipulation by a user, a drive shaft 13 for engaging a socket 40 or other tool and a chain 20 therebetween connecting the handle 11 and the drive shaft 13. The chain 20 may be removably joined to both the handle 11 and socket 40.

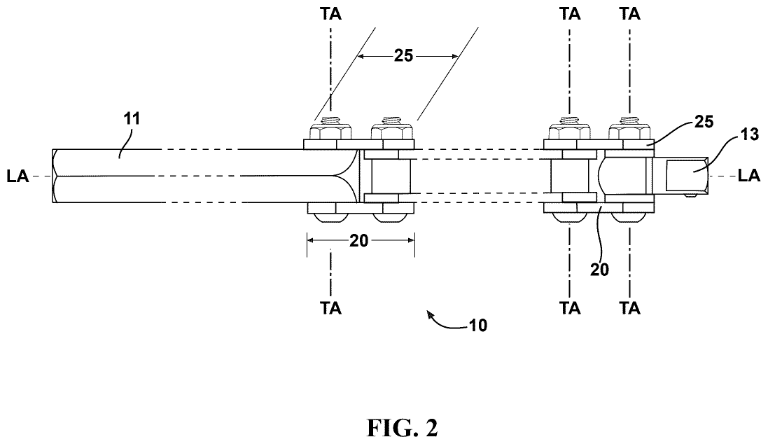

Referring to FIG. 2, the wrench 10 defines a longitudinal axis LA, an associated longitudinal direction and is elongate in the longitudinal direction. The wrench 10, and particularly the chain 20 thereof, has plural transverse axes TA. The transverse axes TA are mutually parallel and perpendicular to the longitudinal axis LA. The transverse axes TA provide hinge points for articulation of the chain 20 thereabout.

The handle 11 may be integral, formed from bar stock in known fashion and as long as necessary for the torque of the particular task and short enough for convenience and to conserve weight.

Longitudinally opposite the handle 11 is a drive shaft 13 to which the socket 40 or other tool, as needed, is removably attached. The drive shaft 13 may be square as is commonly known in the art and have an outwardly spring biased ball for retention as is known in the art. Common drive shafts 13 have dimensions of ¼ inch, ⅜ inch, ½ inch, ¾ inch and 1 inch. The drive shaft 13 may be made according to the teachings of U.S. Pat. No. 2,963,929 to Barnes, U.S. Pat. No. 4,939,961 to Lee, U.S. Pat. No. 8,196,494 to Brovold, U.S. Pat. No. 8,465,169 to Lin and U.S. Pat. No. 1,469,662 to Leopold the disclosures of which are incorporated herein by reference.

Both the handle 11 and the drive shaft 13 may be joined to the chain 20, at longitudinally opposed ends thereof. The handle 11 and drive shaft 13 may be removably joined to the chain 20 by pins 23, as described below. These pins 23 define the transverse axes TA perpendicular to the length 25 of the link plates 21 throughout the chain 20.

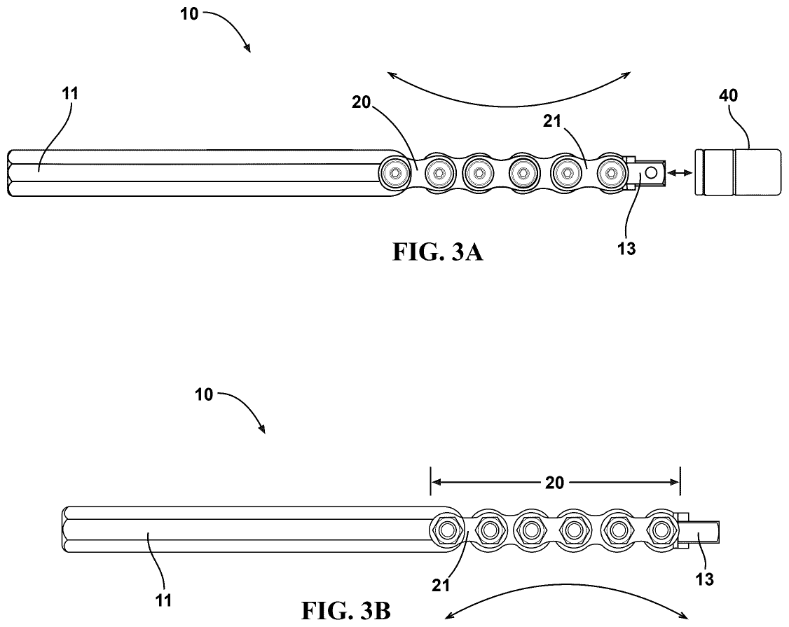

Referring to FIG. 3A and to FIG. 3B cumulative articulation about two or more of the transverse axes TA provide for the chain 20 to bilaterally bend in the directions of the opposed arrows. Such articulation, and resultant bending of the chain 20, provide the benefit that the chain 20 can reach into confined spaces and allow the socket 40 to engage the threaded fastener. Once the threaded fastener is engaged the user can apply clockwise and counterclockwise torque to tighten and loosen the threaded fastener. The socket 40 may be removably attached to the drive shaft 13 while the chain 20 is straight, as shown. The present invention provides the benefit that the same wrench 10 can bend bilaterally in either direction as shown or on a combination of both opposed directions along the length of the chain 20.

The chain 20 should have a sufficient number of links to allow for flexibility when performing various tasks, but not so many links at to become unwieldly. The chain 20 may have from 3 to 15 links and preferably 5 to 9 links. This geometry provides the benefit that a 35H or 50H chain 20 having a ½ inch drive shaft 13 will have a length of 3 to 5 inches as measured from the proximal end of the drive shaft 13 to the proximal end of the chain 20 as connected to handle 11. A chain 20 which is 4 inches long has been found suitable for a variety of common tasks involving confined spaces.

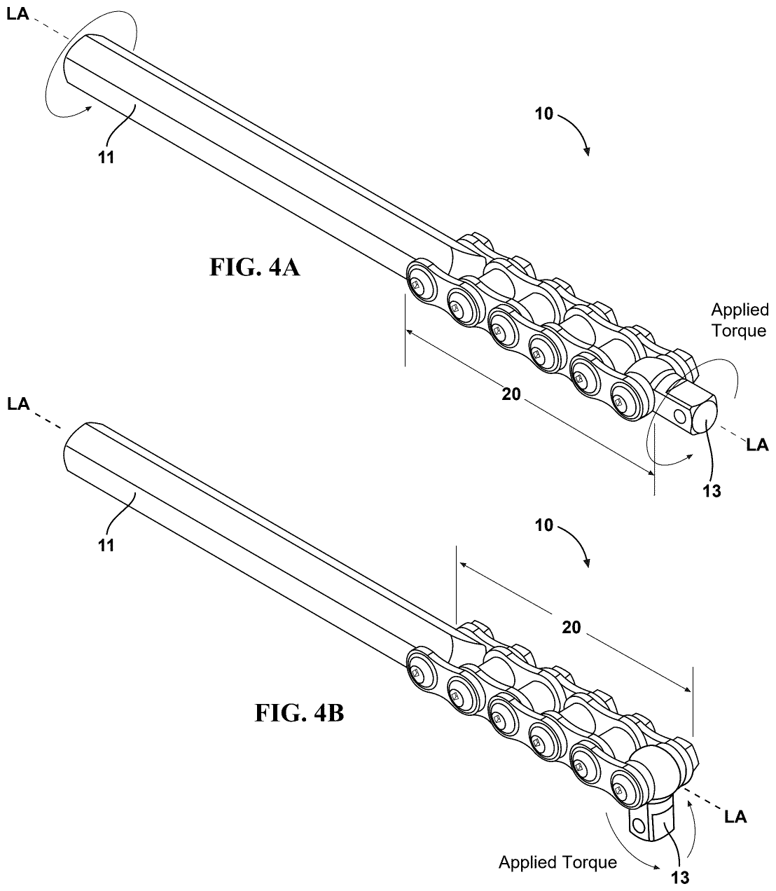

Referring to FIG. 4A, the wrench 10 may be used for rotation about the longitudinal axis LA with torque applied in the clockwise or counterclockwise direction as shown. This arrangement provides the advantage that the wrench 10 may be used as a speed tool with the drive shaft 13 coincident the longitudinal axis LA. A handle 11 having the hexagonal cross section as shown may be used with a standard socket 40 and ratchet combination.

Referring to FIG. 4B, the wrench 10 may be used for rotation perpendicular to the longitudinal axis LA with torque applied in the counterclockwise direction as shown or applied in a clockwise direction. This arrangement provides the advantage that the wrench 10 may be used for high torque tightening/loosening applications with the drive shaft 13 perpendicular to the longitudinal axis LA. Preferably the wrench 10 has limited deflection in the torque directions.

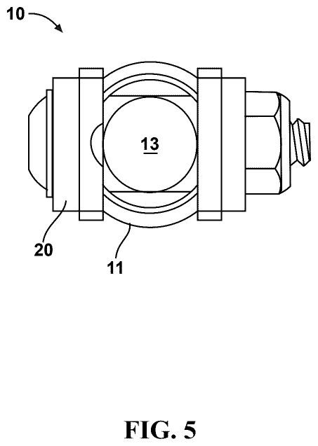

Referring to FIG. 5 the drive shaft 13 may be removably joined to the chain 20 by a through bolt attached with a nut. The drive shaft 13 may be sized for the particular task under consideration. A larger drive shaft 13 may be used for high torque maintenance while a smaller drive shaft 13 may be used for relatively narrower openings.

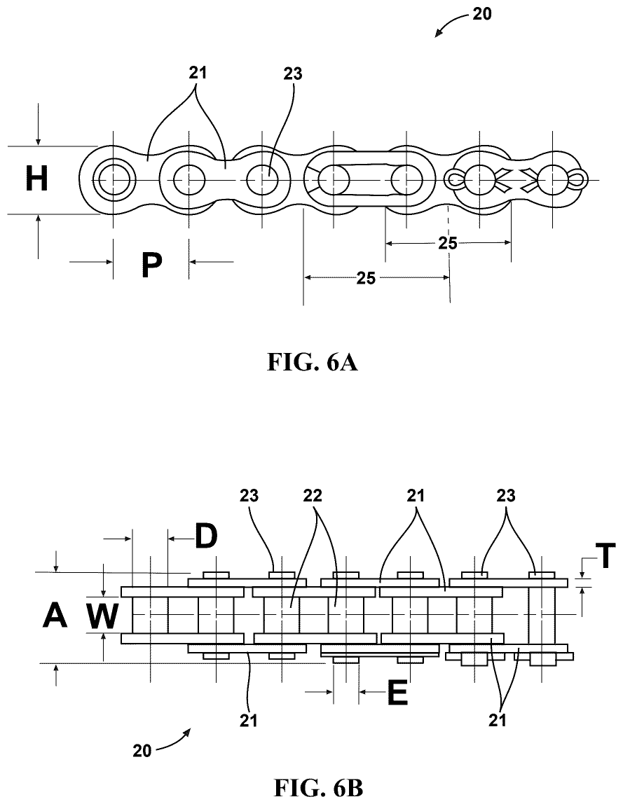

Referring to FIG. 6A and FIG. 6B, the chain 20 may be a common roller chain 20. The chain 20 is a series of alternatively assembled roller 22 links and pins 23 in which the pins 23 articulate inside bushings and the rollers 22 are free to turn on the bushings. Pins 23 and bushing are press fit into the respective link plates 21. Roller chains 20 may be single strand, as shown or, multi-stand, having plural rows of roller 22 links for strength.

The chain 20 is made of various components joined in regular, repeating units. An outer link plate 21 is the outermost plate are combined with pins 23 to form what is known as a pin link or riveting link. The outer link plates 21 can absorb shock load. Inner link plates 21 hold the bushing and the roller 22 to form a unit length. The link plate 21 is generally planar and has the shape of a quartic plane curve, particularly a Cassini oval having a bulbous shape at each end.

The pins 23 hold the chain 20 together by connecting roller 22 links. The pins 23 are the main bearing point under roller 22 contact. The bearing point is the point at which the chain 20 would flex or pivot around a sprocket, if present. Rollers 22 ride directly on the sprocket, if present. A bushing (not shown) may be concentrically disposed between the pin 23 and the roller 22 and can absorb impact loads.

The pins 23 and bushings act as individual, longitudinally spaced hinges. The pins 23 are held in place by nuts and bolts. Each pin 23 forms a transverse axis TA about which the rest of the chain 20 can articulate. The center of each such hinge, and transverse axis TA, is at the center of each concentric pin, bushing, roller 22 assembly.

Roller 22 links are the inner repeating units of a roller chain 20 that are made using the inner plates, bushings and rollers 22. Riveting links are made from the pins 23 and outer link plates 21. These links are used between each roller 22 link to form a roller chain 20. The pins 23 and outer plates are a pressed to form a solid connection. Links are held onto place on the rollers 22 in known fashion by spring clips or cotter pins.

The chain 20 of the wrench 10 has a length and a length direction parallel to and coincident the longitudinal axis LA. The link plate 21 has the following planar dimensions: a height H taken perpendicular to the length of the chain 20 and within the plane of the link, wherein the height H is the maximum dimension of the link plate 21 perpendicular to the length of the chain 20; a link length 25, a pitch P taken along the length of the chain 20 as the distance between centerlines of adjacent pins 23; a roller 22 width W taken perpendicular to the length of the chain 20 as the distance between the inner surfaces of corresponding inner link plates 21; a roller 22 diameter D taken in the length direction as the diameter of the rollers 22; an overall width A taken perpendicular to the length of the chain 20 as the maximum width across ends of the pins 23; a plate thickness T taken perpendicular to the length direction of the chain 20 as the thickness of a single plate and a pin 23 diameter E taken in the length direction as the diameter of a pin.

Referring to FIG. 6C, ANSI/ASME B29 standards govern roller chains 20. There are 14 domestic common ANSI sizes of chains 20 numbered 25, 35, 40, 50, 60, 80, 100, 120, 140, 160, 180, 200 and 240. An 80 roller chain 20 is defined as a 1-inch pitch P chain 20 as signified by the first number “8” in the chain 20 part number. Pitch P is determined by dividing the first number of chain 20 part number by 8 (8/8=1″ Pitch P). An H suffix designates a heavier chain 20 with thicker link plates 21.

Roller chains 20 may be made according to ANSI B29.1 standard, and particularly according to ASME Standard B29.1-2011 (R2022), Precision Power Transmission Roller Chains, Attachments and Sprockets, or according to ASME Standard B29.28-2015 (R2020), the disclosures of which are incorporated herein by reference. Internationally, chains 20 typically meet JIS B1801, ISO 606A, or ISO 1395C standards, the disclosures of which are incorporated herein by reference.

The chain 20 has an aspect ratio taken as the ratio of the maximum dimensions of the overall width A to the maximum height H of the link plate 21, and denominated A/H. The overall width A determines the section modulus and controls the polar moment of inertia. The polar moment of inertia should be sufficient to allow the user to exert torque about the longitudinal axis LA without undue deformation. The height H is the maximum dimension of the link plate 21 and determines the width of the space into which the wrench 10, and particularly the chain 20 thereof, can fit.

The width A is preferably greater than the height H, so that the polar moment of inertia is sufficient for high torque applications while the height, which forms the thickness of the chain 20 is small enough to allow the chain 20, drive shaft 13 and socket 40 into narrow openings. The thickness of the chain 20 is perpendicular to the longitudinal axis LA and the transverse axes TA.

The aspect ratio is greater than 1 to provide for increased torque in a narrow opening. The aspect ratio is preferably greater than 1.1, 1.2, 1.3 and 1.4, but less than 2.0 and preferably less than 1.9. The aspect ratio may be inherent in an ANSI chain 20, as shown or may be achieved by manufacturing and assembling a chain 20 in known manner to yield the desired aspect ratio.

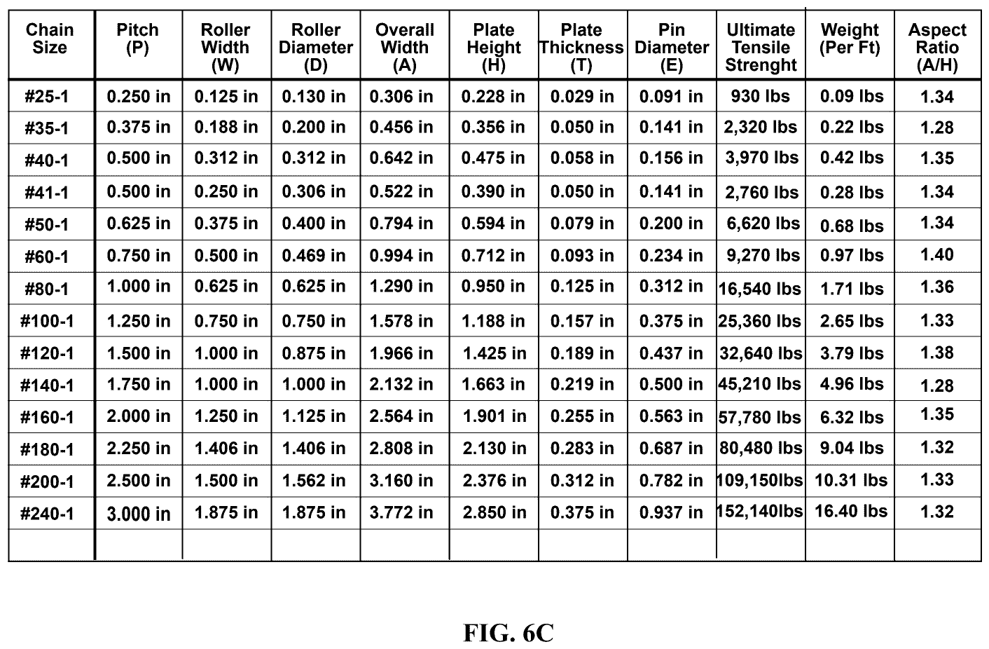

Referring to FIG. 7A and FIG. 7B, the socket 40 may be a closed 6 point hex socket 40 or closed 12 point duodecimal socket 40 as are known in the art. The socket 40 has a hex or duodecimal bore 42 which fits onto a nut 43, the head of a bolt, etc. Opposed to the duodecimal bore 42 is a square bore 41 into which the drive shaft 13 is inserted to apply torque when engaging the nut 43 or other threaded fastener.

Sockets 40 may be made according to U.S. Pat. No. 3,273,430 to Knudsen et al and to U.S. Pat. No. 9,718,170 to Eggert et al., the disclosures of which are incorporated herein by reference. Sockets 40 may be closed as shown, or may be open as occurs with a crowfoot socket 40 and open ended socket 40.

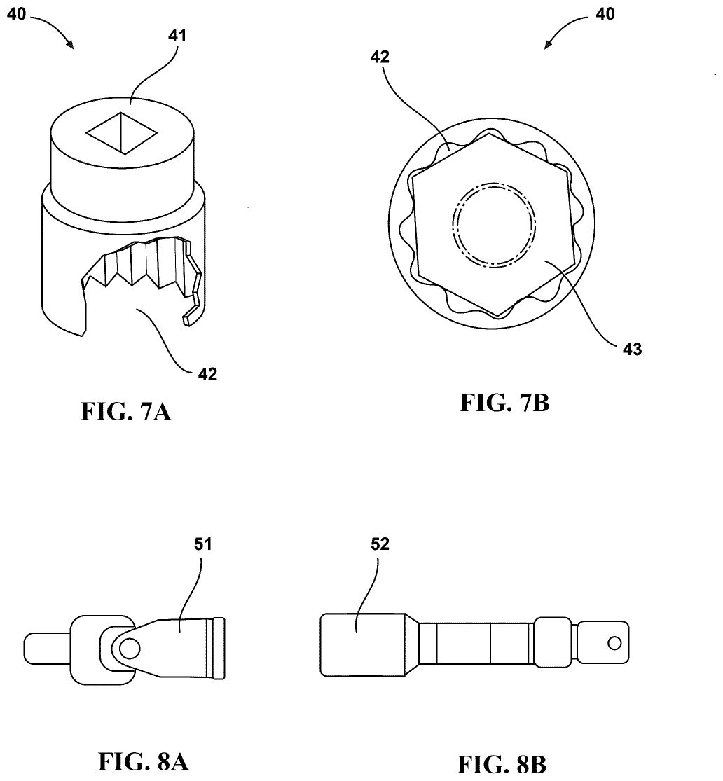

Referring to FIG. 8A and FIG. 8B the wrench 10 of the present invention may be used with a standard adapter 51 or extension 52, as are commercially available. However it is expected the adapter 51 or extension 52 will not typically be used for maintenance involving confined spaces.

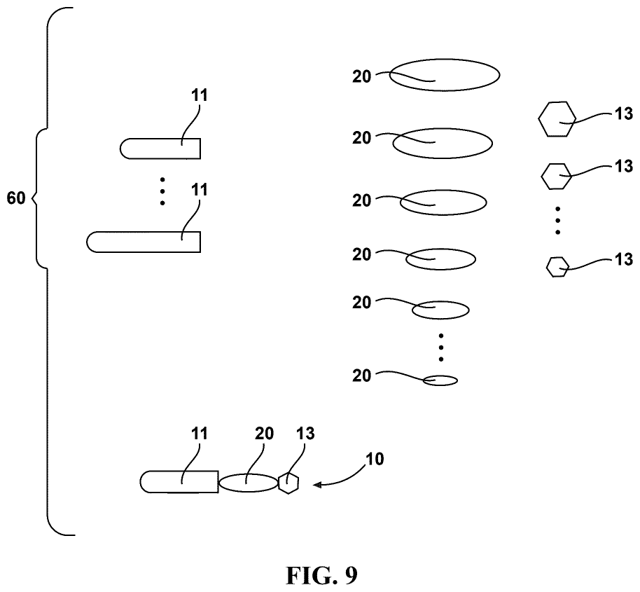

Referring to FIG. 9, if desired, the wrench 10 of the present invention may be suppled in a kit. The kit may have a plurality of handles 11, plurality of chains 20 and plurality of drive shafts 13. The handles 11 may have different lengths and different polar moments of inertia to balance the need for sufficient torque and thickness to fit into the confined space. Likewise, the chains 20 may have different lengths and polar moments of inertia to similarly balance the need for sufficient torque and thickness to fit into the confined space. The drive shaft 13 may be selected for the socket 40 most suitable for the task under consideration.

The user selects the appropriate handle 11, chain 20 and drive shaft 13. The selected handle 11, chain 20 and drive shaft 13 may be selected and assembled to form a wrench 10 custom fitted for the particular task. The socket 40 is removably attached to the drive shaft 13, and then engaged with the desired threaded fastener. The chain 20 is articulated about plural transverse axes TA as needed to extend the wrench 10 from where the user grasps the handle 11 to where the socket 40 engages the threaded fastener. The transverse axes TA about which articulation occurs may be spaced apart with a transverse axis TA therebetween about which articulation need not occur. The user then applies clockwise or counterclockwise torque to the threaded fastener as necessary for the maintenance.

All values disclosed herein are not strictly limited to the exact numerical values recited. Unless otherwise specified, each such dimension is intended to mean both the recited value and a functionally equivalent range surrounding that value. For example, a dimension disclosed as “40 mm” is intended to mean “about 40 mm.” The term “or” as used herein is to be interpreted as an inclusive or meaning any one or any combination. Therefore, “A, B or C” means “any of the following: A; B; C; A and B; A and C; B and C; A, B and C.” Every document cited herein, including any cross referenced or related patent or application, is hereby incorporated herein by reference in its entirety unless expressly excluded or otherwise limited. The citation of any document or commercially available component is not an admission that such document or component is prior art with respect to any invention disclosed or claimed herein or that alone, or in any combination with any other document or component, teaches, suggests or discloses any such invention. Further, to the extent that any meaning or definition of a term in this document conflicts with any meaning or definition of the same term in a document incorporated by reference, the meaning or definition assigned to that term in this document shall govern according to Phillips v. AWH Corp., 415 F.3d 1303 (Fed. Cir. 2005). All limits shown herein as defining a range may be used with any other limit defining a range of that same parameter. That is the upper limit of one range may be used with the lower limit of another range for the same parameter, and vice versa. As used herein, when two components are joined or connected the components may be interchangeably contiguously joined together or connected with an intervening element therebetween. A component joined to the distal end of another component may be juxtaposed with or joined at the distal end thereof. While particular embodiments of the present invention have been illustrated and described, it would be obvious to those skilled in the art that various other changes and modifications can be made without departing from the spirit and scope of the invention and that various embodiments described herein may be used in any combination or combinations. It is therefore intended the appended claims cover all such changes and modifications that are within the scope of this invention.

What is claimed is:

1. An elongate wrench for rotating a threaded fastener, the wrench defining a longitudinal axis and comprising:
a handle having a first handle end and a second handle end opposed thereto;
a chain having a first chain end joined to the handle and a second chain end opposed thereto and spaced outwardly from the handle; and
a drive shaft joined to the second end of the chain and configured to insert into a bore of a socket, whereby the chain is articulable about a plurality of transverse axes perpendicular to the longitudinal axis and can apply torque about the longitudinal axis in response to a user.

2. A wrench according to claim 1 wherein the chain has an aspect ratio ranging from 1.1 to 2.0.

3. A wrench according to claim 2 wherein the links comprise elongate serial interconnected link plates having opposed ends, each opposed end having a link plate hole therethough, the interconnected link plates being joined by pins through the respective link plate holes, the link plates having a height H, the chain having an overall width A, the chain having an aspect ratio H/A ranging from 1.1 to 1.4.

4. A wrench according to claim 3 wherein the chain is from 4 to 6 inches in length.

5. A wrench according to claim 4 wherein the chain has a pitch ranging from ⅜ inch to ⅝ inch.

6. A wrench according to claim 5 having a 35H chain or 50H chain.

7. A kit comprising a modular elongate wrench for rotating a threaded fastener, the wrench defining a longitudinal axis, the kit comprising:
at least one elongate handle coincident the longitudinal axis and having a first handle end and a second handle end opposed thereto;
at least one chain having a proximal end removably joinable to the handle proximate the second handle end and having a distal end opposed to the proximal end and being spaced away from the handle; and
at least one drive shaft removably joinable to the distal end of the chain and configured to insert into a bore of a socket, whereby the chain is articulable about a plurality of transverse axes perpendicular to the longitudinal axis and can apply torque about the longitudinal axis.

8. A wrench according to claim 1 having a plurality of chains with respective mutually different aspect ratios, the aspect ratios ranging from 1.1 to 2.0.

9. A kit according to claim 8 comprising plural drive shafts interchangeably disposable on a respective chain.

10. A kit according to claim 9 comprising a ⅜ inch square drive shaft and a ½ inch square drive shaft.

11. A method of tightening or loosening a threaded fastener, the method comprising, in order, the steps of:
providing a modular wrench for rotating a threaded fastener and defining a longitudinal axis, the wrench having at least one elongate handle coincident the longitudinal axis with a first handle end and a second handle end opposed thereto, at least one chain having a proximal end removably joined to the handle and a distal end opposed thereto and spaced outwardly from the handle, whereby the chain is articulable about a plurality of transverse axis perpendicular to the longitudinal axis, and a drive shaft removably joined to the distal end of the chain and configured to insert into a bore of a socket;
removably attaching a first socket to the drive shaft;
engaging the first socket with a threaded fastener; and
applying torque about the longitudinal axis of the wrench to thereby rotate the threaded fastener about a respective threaded fastener axis.

12. A method according to claim 11 further comprising the step of inserting the first socket into a confined space before engaging the first socket with the threaded fastener.

13. A method according to claim 12 further comprising the step of selecting the chain from a kit having a plurality of chains, each chain of the plurality of chains having an aspect ratio ranging from 1.1 to 2.0, and attaching the selected chain to the handle before applying torque about the longitudinal axis.

14. A method according to claim 13 wherein the step of selecting a chain from a kit having a plurality of chains comprises the step of selecting a chain from a plurality of chains wherein each has a drive shaft attached to the distal end thereof.

15. A method according to claim 13 wherein the step of selecting a chain from a kit having a plurality of chains comprises the step of selecting a chain not having a drive shaft associated therewith and further comprises the steps of:
selecting a drive shaft from a plurality of drive shafts; and removably joining the selected drive shaft to the distal end of the chain before removably attaching the first socket to the selected drive shaft.

16. A method according to claim 12 further comprising the step of articulating the chain about plural transverse axes after removably attaching the first socket to the drive shaft and before engaging the first socket with the threaded fastener.

17. A method according to claim 16 further comprising the articulating the chain in plural angles about each of plural transverse articulating axes while rotating the threaded fastener about a respective threaded fastener axis.

18. A method according to claim 17 wherein the step of articulating the chain in plural angles about each of the plural transverse articulating axes comprises the step of articulating the chain in opposed directions about at least one of the transverse articulating axes.

19. A method according to claim 18 wherein the step of articulating the chain in plural angles about each of the plural transverse articulating axes comprises the step of articulating the chain in opposed directions about at least two of the transverse articulating axes.

20. A method according to claim 19 wherein the at least two transverse articulating axes have at least one transverse axis therebetween not subjected to articulating in opposed directions.
